(19) United States
(12) Patent Application Publication
(10) Pub. No.: US 2022/0397269 A1
(43) Pub. Date: Dec. 15, 2022

(54) NON-COMBUSTION SYSTEM FOR WASTE DESTROY

(71) Applicants: Sudhir Kanubhai PARMAR, Ahmedabad, Gujarat (IN); Bhavini Sudhir PARMAR, Ahmedabad, Gujarat (IN)

(72) Inventors: Sudhir Kanubhai PARMAR, Ahmedabad, Gujarat (IN); Bhavini Sudhir PARMAR, Ahmedabad, Gujarat (IN)

(21) Appl. No.: 17/771,452

(22) PCT Filed: Feb. 21, 2020
(86) PCT No.: PCT/IB2020/051461

§ 371 Date: Apr. 22, 2022

(30) Foreign Application Priority Data
Oct. 22, 2019 (IN) 201921042860

(51) Int. Cl. F23G 5/08; B09B 3/40; B09B 3/50; B09B 3/70

(52) U.S. Cl. CPC F23G 5/085; B09B 3/40; B09B 3/50; B09B 3/70; B09B 2101/25

(57) ABSTRACT

Present invention relates to a non-combustion machine or system for waste destruction or decomposition and exhaust clean and non-harm fill gas to atmosphere. The present invention uses plasma heat generated by the exothermic reaction taking place between the organic substances of the solid waste and ionised air contained in the solid waste machine. After this reaction, generated flue gas is filtered; cleaned and then exhausted to make the atmosphere healthier to the lives.

### FIELD OF INVENTION

Present invention relates to a non-combustion machine or system for waste destruction or decomposition and exhaust clean and non-harmful gas to atmosphere. The present invention uses plasma heat generated by the exothermic reaction taking place between the organic substances of the solid waste and ionised air contained in the solid waste machine. After this reaction, generated flue gas is filtered; cleaned and then exhausted to make the atmosphere healthier to the lives.

### BACKGROUND OF INVENTION

In the report of the World Bank study it is mentioned that around the world, waste generation rates are rising. In 2016, the worlds' cities generated 2.01 billion tones of solid waste, amounting to a footprint of 0.74 kilograms per person per day. With rapid population growth and urbanization, annual waste generation is expected to increase by 70% from 2016 levels to 3.40 billion tones in 2050.

Compared to those in developed nations, residents in developing countries, especially the urban poor, are more severely impacted by unsustainably managed waste. In low-income countries, over 90% of waste is often disposed in unregulated dumps or openly burned. These practices create serious health, safety, and environmental consequences. Poorly managed waste serves as a breeding ground for disease vectors, contributes to global climate change through methane generation, and can even promote urban violence.

Managing waste properly is essential for building sustainable and livable cities, but it remains a challenge for many developing countries and cities. Effective waste management is expensive, often comprising 20%-50% of municipal budgets. Operating this essential municipal service requires integrated systems that are efficient, sustainable, and socially supported.

In Global waste management conference 2017 it was disclosed that based on estimates, the world cities generated 1.3 billion tons of waste annually with Asia accountable for 1 million tones per day. With current urbanization and population growth rate, the global waste generation is estimated to rise up to 2.2 billion tones by 2025. A World Bank study showed that urban areas in Asia spent USD25 million per year on solid-waste management, and this figure will increase to USD47 million per year. Despite the huge expenditures, urban areas in most Asia pacific are still grappling with the challenge of preventing environmental degradation due to non-systematic waste management.

Apart from the contamination of water resources and severe air pollution, the health hazard is another key issue to be addressed. Waste management has become an important issue in the Asia-Pacific region for building sustainable and livable cities, and it needs to be resolved through an integrated systems that are efficient, sustainable, and socially supported, and policy-based approach.

In a paper of Health impacts of solid waste it is said that modernization and progress has had its share of disadvantages and one of the main aspects of concern is the pollution it is causing to the earth—be it land, air, and water. With increase in the global population and the rising demand for food and other essentials, there has been a rise in the amount of waste being generated daily by each household. This waste is ultimately thrown into municipal waste collection centers from where it is collected by the area municipalities to be further thrown into the landfills and dumps. However, due to either resource crunch or inefficient infrastructure, not all of this waste gets collected and transported to the final dumpsites. If at this stage the management and disposal is improperly done, it can cause serious impacts on health and problems to the surrounding environment.

For healthy living in clean environment, if waste is not properly decomposed or managed that will cause to spread infectious diseases.

Waste treatment and disposal sites can also create health hazards for the neighborhoods. Improperly operated incineration plants cause air pollution and improperly managed and designed landfills attract all types of insects and rodents that spread diseases.

Many studies have been carried out in various parts of the world to establish a connection between health and hazardous waste.

Proper methods of waste disposal have to be undertaken to ensure that it does not affect the environment around the area or cause health hazards to the people living there.

There is a population of about 1.3 billion people of India, generates 1.33 metric ton per day of municipal solid waste (MSW), hence it will require 1240 hectors of precious land every year to accommodate untreated solid waste and subsequently all these land fill sites making all kinds of pollution like, air, water and irrevocable soil contamination. Thus, there is an urgent need to find economically viable and sustainable solution for solid waste at the point of generation or collection to minimize its transportation and avoid subsequent pollution and environmental hazards.

To overcome the above said problems or waste management issues, several inventions were done for waste incineration that can be either manually or electrically, which is one or the other way inconvenient to the user. Further when solid waste is managed by combustion method the gas out coming/liberating through chimney directly to the atmosphere is hazardous.

U.S. Pat. No. 9,518,733B1, Furnace apparatus, is claiming for combustion method wherein stirrer is placed at the bottom, which needs electricity. Further gas coming out through chimney into the atmosphere is hazardous in this system.

U.S. Pat. No. RE34298E claims a method of thermal destruction of waste material, which is an afterburner apparatus and an incineration system and methods of waste destruction in primary incineration combustion means arranged with rotator kilns and afterburner means fed with fuel. In U.S. Pat. No. 9,518,733B1, system does the incineration of the disposed waste whereas in U.S. Pat. No. RE34298E solid or liquid gases are used for combustion.

To overcome all aforesaid problems and make the waste management easy operative a machine and/or system is invented. First embodiment of the present invention is to develop a non-combustion system to destroy waste and exhaust clean/non harmful gas to atmosphere. This waste can be solid or semi solid i.e. dry or wet. Another embodiment is to develop a furnace system to destroy waste using less manpower and less electricity and without using stirrer for waste destroy. In addition, another embodiment of the present invention is to maximize use of natural power or energy source and exhaust clean gas to the nature/environment. Hence, solar power/energy used for automatic control of dumping, filtering gases and plasma controlling system while the decomposition process itself does not use any electricity or gases or other fuel and exhaust clean/non harmful gas to the atmosphere.

In another embodiment of the present invention dumping system is totally free of man-power and/or using less electricity. The solar panels with assistance of charge controller, charges the battery banks of the system. The solar inverter provided in the system change direct current (DC)-output of battery bank in to a utility frequency alternating current (AC). An optional power backup is also provided by optional generator/AC main supply, which stores the energy in battery bank and can be used when the solar panel is not working or/not getting sunlight or/due to any consequences/or in critical situations/or in case of power cut and no electricity area.

DETAILED DESCRIPTION OF FIGURES

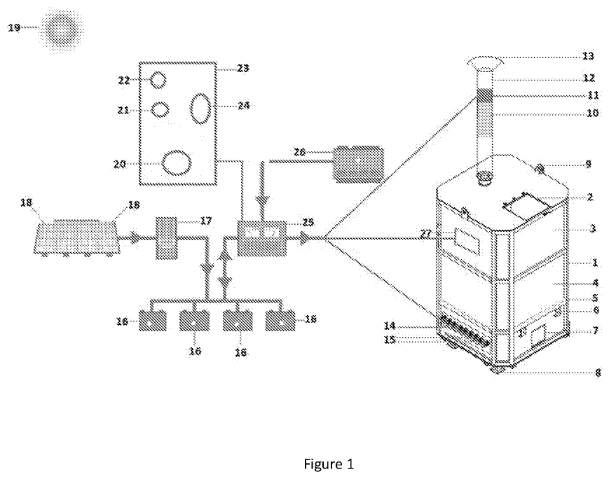

FIG. 1 is layout of non-combustion system for waste destroy

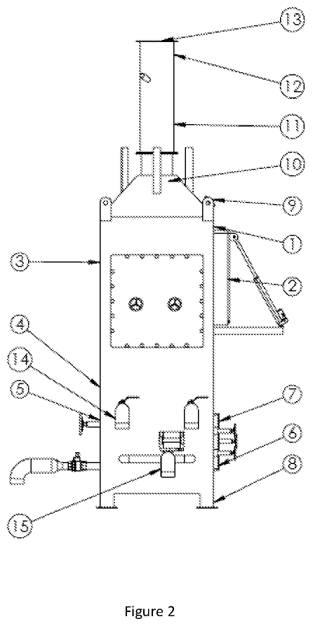

FIG. 2 is Side view of the machine or system

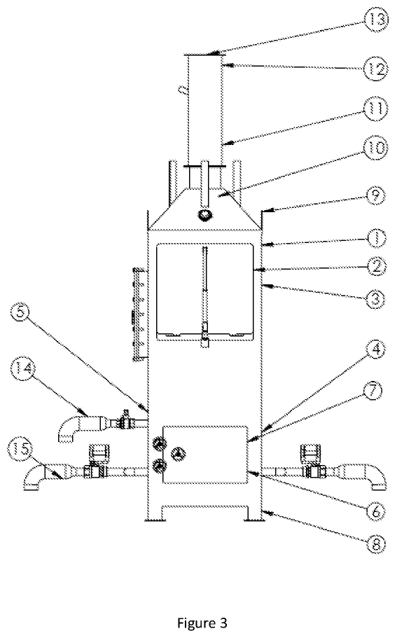

FIG. 3 is Front view of the machine or system

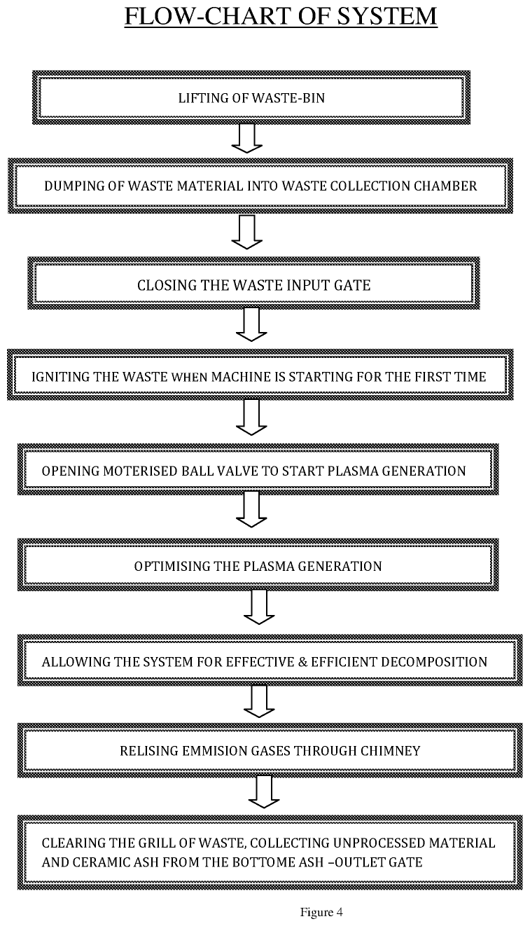

FIG. 4 is flow chart of the process working of machine

A present invention comprises non-combustion machine or system for destroy of waste and exhaust clean gas into the atmosphere as shown in FIG. 1. M.S. body container 1 in which waste material is disposed off, having top openable inlet door 2 for waste insertion, upper zone 3 of container for dehumidification, lower zone 4 of container for decomposition, s. s. grill 5 for holding waste material initially and then holding non-organic unprocessed waste material like glass, metal etc., lever arrangement 6 for ash and residual collection system, outlet door 7 for facilitating collection of ash and residuals, sturdy base-leg 8 for container/destroyer, lifting tug 9, various types of flue gas-filters and cleaners placed in part 10 of pipe, solar powered blower 11, M.S. chimney 12, cap of the chimney 13, plasma generators 14, solar powered self actuating valves 15, battery bank 16, charge controller 17, solar panels 18, indicator 20 for showing location of machine, clock 21, valve opening indicator 22, control panel 23, temperature indicator 24, inverter 25, optional generator 26, sensors for temperature 27.

In system of the present invention principal parts with its functions mentioned below:

1. Main body: in which whole process of the non-combustion_system is carried out.

2. Chimney: a part of machine which carry away exhaust liberated gas during waste destruction process

3. Activated filter: The liberated gases are filtered and expelled clear air through activated filter

4. Thermo-couple: it is a sensor used to measure temperature and consists of two wire legs made from different metals and digital display. It indicates accurate temperature and temperature difference during process and also ensures safety in case of temperature exceeds more than 400° C.-500° C. It transmits the signals to control panel which in turn optimizing the opening/closing of motorized ball valve for stabilizing plasma state in the body.

5. Waste inlet door: A lid or inlet door which is opened for inserting the solid waste in the system

6. Electrical actuator: actuator-electrical equipment which is responsible for opening and closing of the lid or waste inlet door

7. Man-Hole: Provision of Door for maintenance purpose.

8. Ash outlet door: Accumulated ash on plate or tray can be collected or discarded from the ash outlet door

9 and 10 are Manual and Motorised plasma generator respectively. This equipment generates ionized air and thereby plasma which decomposes the waste in the body. It is driven manually or by electromotor in accordance with the programmed control panel

### DETAILED DESCRIPTION OF INVENTION

Present invention relates to a non-combustion machine or system for destruction or decomposition of waste and exhaust clean gas into the atmosphere. The present invention uses ionized air and thereby plasma Immense heat is generated by the exothermic reaction when the ionized air reacts with the organic substances contained in the solid waste. After this reaction, non-hazardous flue gas is generated which is filtered, cleaned and exhausted as clean gas to atmosphere to make the atmosphere healthier to the lives.

The present invention is to develop a non-combustion system to destroy or destruction or decomposition of dry or wet waste and to exhaust clean and non harmful gas to atmosphere. The present invention is to develop a furnace system without using stirrer for waste destroy and without using any energy for process and using less manpower and bare-minimum electricity, The invention for destruction or decomposition, uses renewable energy - solar power to operate the system and to exhaust clean and non harmful gas to the atmosphere.

The present invention is fully automatic and almost free of man power and with minimum electricity. The solar panels with the assistance of charge controller, which charges the battery banks, inverter which converts dc in to ac supply, optional generator etc. is used for effective performance of the system.

A system of decomposition can be divided in to four zones wherein a. first zone is upper part of the system which involves hopper on top or via side opener, and an arrangement of exhaust and liberation of gas after filtration wherein gas is expelled out through activated filter and chimney respectively, b. second zone of the system is solid waste collection chamber in which waste without segregation inserted via upper lid or side opener wherein solid waste is deposited or placed on a S.S. grill where being the waste decomposition starts without need of energy and continues till empty of this chamber, c. third zone of the system is plasma generation part which is located below the stainless steel grill mentioned in b. wherein air passing through controlled ball valve and series of earth magnets and generates ionized air and thereby plasma which continuously react with the waste and exhibits the exothermic chain reactions and thus decomposition of solid waste exaggerates at controlled temperature by ball valve and plasma generator d. fourth zone of the system is ash collection where ash is collected in plate or tray and discarded through tray removing from ash outlet door.

Waste can be inserted into waste collection chamber by direct dumping via upper lid or hopper or collected waste can also be inserted through hopper type bin lifter/or vertical bucket elevator which is automatically operated and dump the solid waste into the waste collection chamber either via hopper or side opener. After insertion of solid waste into the system, the lid closed by electrical actuator. The process steps forward with the first ignition and resulting in temperature rise in the system. The oxygen contained in the entrapped air of the body consumed by ignition in couple of minutes. Hence, oxygen starved condition prevails in the body. The system starts sucking air through plasma generator through actuated ball valve and high power magnets produces ionized air. Plasma generator thus produces high magnetic vibrations in upward direction to decompose the solid waste. The process continues with air containing oxygen molecules, which passes through the specifically arranged rare earth magnets and produces plasma which reacts with waste continuously in the series of exothermic reaction. This process undergoes in oxygen-starved condition where ionized air acts major role to accomplish the oxygen molecules and generates low temperature plasma in the system which initiate the process of decomposition and therefore no hazardous gas is generated during the process. Programmed Control-panel regulates the decomposition process by continuously operating ball valves and thereby generating plasma and maintaining temp. range between 400° C.-500° C. for efficient and effective decomposition. If Temperature well below 150° C. is reached in the body even after due opening of ball valves, the system will sense the condition of ‘NO WASTE IN THE BODY’ and the hooter rings indicating no solid waste in the system. Control panel will also actuate the dumping system i.e. Bin lifter/vertical bucket elevator will waste, upper lid will opens by self actuating valve and solid waste will be dumped by bin lifter/bucket elevator for continuous decomposition process in the body.

During the plasma decomposition process in oxygen starved condition, no hazardous gas will be generated. However, generated flue gas is filtered, cleaned and then clean gas to atmosphere is exhausted.

The body of the system is made up of furnace grade mild steel which is advantageous for high temperate decomposition process. When system is used for the first time, ignition is initiated by electric lighter/fire balls/manually. No ignition required thereafter during the process until dumping of waste at prescribed interval is done.

Waste destruction processes of the present invention are described in more detail with reference to the following examples. These examples are provided by way of illustration only and should not be construed as to limit the scope or spirit of the appended claims in any manner System of the present invention as described herein is suitable for making or using in the industry.

The machine or system of the present invention comprises specially designed two processes.

### A] Paramagnetic upward air flow.

After initial ignition of the municipal solid waste (MSW), the entrapped oxygen contained in the empty volume of vessel consumed in the ignition. As the vessel is closed now, the dropped pressure in the vessel starts sucking air from the plasma generator provided at the lower half. The heavy duty self actuating ball valve controls the air flow to create oxygen starved condition in the processing unit. The decomposing reaction within MSW initiated when controlled quantity of air is allowed to enter in to the processing compartment through high magnetic vibration created by the series of high power rare earth magnets in a specially designed cylinder configuration. Quantity of air and thereby oxygen which is controlled by the valves is derived and passed through the typical cylindrical arrangements of combination of rare earth magnets to produce highly activated ionized oxygen atoms which initiate the series of exothermic chain reaction to destroy the total mass contained in the vessel. Thus after the initial spark/ignition in the dumped waste, the process of destruction starts slowly by splitting the oxygen molecules in to the atoms, atoms due to high magnetic vibration further ionized as outer electrons jumps away from its balanced designated orbits and thereby liberating immense heat. Highly activated and unstable atoms further used to destabilized the neighboring organic molecule. This ionized plasma state air vortex generated in oxygen starved condition due to high magnetic vibration flows in upward direction to decompose and to destroy the MSW.

A non-combustion system without stirrer for destruction of waste material and exhaust of clean gas to the atmosphere in process A comprises:
a. Initial ignition of the municipal solid waste (MSW)
b. The entrapped oxygen contained in the empty volume of vessel consumed in the initial momentarily ignition
c. Keep the vessel closed
d. Dropped pressure in the vessel starts sucking air from the plasma generator provided at the lower half
e. Heavy duty solar powered self actuating ball valve controls the air flow to create oxygen starved condition in the processing unit
f. The decomposing reaction within MSW initiated when controlled quantity of air is allowed to enter in to the processing compartment with high magnetic vibration created by passing it through series of high power rare earth magnets in a specially designed cylinder configuration
g. Quantity of air and thereby oxygen which is controlled by the valves is derived and passed through the typical cylindrical arrangements of combination of rare earth magnets to produce highly active and unstable ionized oxygen atom which initiate the series of exothermic chain reaction with waste to destroy the total mass contained in the vessel
h. After the initial spark/ignition, the process of destruction starts slowly by splitting the oxygen molecules in to the atoms, atoms due to high magnetic vibration further ionized as outer electrons jumps away from its balanced designated orbits and thereby liberating immense heat which further used to destabilized the neighboring organic molecule
i. Ionized plasma state air vortex generated in oxygen starved condition due to high magnetic vibration flows in upward direction to decompose and to destroy the MSW.

### B] Homogeneous downward solid waste flow

Manual and automatic dumping systems are designed to feed in to the chamber of vessel at uniform intervals. When MSW is dumped for the first time, it requires starting of fire by using lighter/camphor/dry wood/match stick or by fire balls. As all the doors are closed tightly and ignition starts momentarily, the temperature rises gradually. The specified volume of air allowed to enter through plasma generator and ball valves. The process creates ionized air and thereby plasma produces heat by exothermic reaction as mentioned in Para [A]. This heat dehumidifies the MSW of the upper layer and decomposes the dry MSW of the lower level. The dry MSW turns in to ceramic ash due to plasma decomposition and some non hazardous gas emits in the process These Flue gas is further filtered by diff. equipments provided at the outlet to exhaust clean gas and subsequently emitted to atmosphere from the chimney. The wet MSW after dehumidification enters in to the high temperature lower zone of vassal to get converted further in to ceramic ash.

A non-combustion system without stirrer for destruction of waste material and exhaust of clean gas to the atmosphere in process B comprises:
a. Manual and automatic dumping systems are designed to feed in to the chamber of vessel at prescribed intervals
b. When MSW is dumped for the first time, it requires starting fire by using lighter/camphor/dry wood/match stick or by fire balls
c. Ignition starts in the vessels
d. As all the doors are closed and ignition starts momentarily, the temperature rises gradually
e. The specified volume of air entered through plasma generator and ball valve which creates ionized air and thereby plasma and subsequently heat by exothermic chain reaction
f. Heat generated in step e dehumidifies the MSW of the upper layer and decomposes the dry MSW of the lower level
g. The MSW turns in to ceramic ash due to decomposition caused by immense heat and some non hazardous gas emits in the process
h. Flue gas is further filtered by different equipments provided at the outlet to exhaust clean gas and subsequently emitted to atmosphere from the chimney
i. The wet MSW after dehumidification enters in to the high temperature lower zone of vassal to get converted further in to ceramic ash after due decomposition.

The system is supported with control panel, thermocouple, temperature indicator, GPS locator, solar panel and power storage battery bank, Programmable Logic Controller (PLC) etc. designed to increase applicability of the system in all type of circumstances. Solar panel produces solar energy as a natural renewable energy source and power storage or battery bank is used when there is power cut or no electricity. Furthermore, the system comprises thermocouple that indicates accurate and real time temperature measurements

The system comprises digital and intelligent support to keep continuous check and alert of the status of the process and other important parameters. Control panel with digital display shows the location of system, real time temperature measurements, opening of plasma generators, parameters of ambient atmosphere like temperature, humidity etc., and Sim-card with Wi-Fi connectivity for data transfer facility.

### C] Automatic operation of machine

a. Bin lifter lifts up solid waste and dump waste in to the system through waste inlet door/lid
b. Electrical actuator automatically operates opening and closing of waste inlet lid
c. Mechanism commences with ball valve and plasma generator by opening of the motorized ball valve
d. Ball valves and Plasma generator actuated by supply of electrical signals, allow air through rare earth magnets to produces ionized air to create plasma in the body.
e. Programmable Logic Controller (PLC) of the Control panel is programmed to sense real time temperature for creating and stabilizing plasma generation required for decomposition of waste
f. Depending upon the quantity and moisture content of the solid waste inserted in the system Effective decomposition continues at preferred temperature by automatic control of plasma generator through Programmable Logic Controller (PLC).
g. Liberation of emission gases passing through filters and expelled out from chimney

We claim:

1. A non-combustion system without stirrer for destroy of waste material and exhaust of clean gas to the atmosphere comprises:
a) Initial ignition of the municipal solid waste (MSW)
b) The entrapped oxygen contained in the empty volume of vessel consumed in the initial ignition process
c) Keep the vessel closed
d) Dropped pressure in the vessel starts sucking air from the plasma generator provided at the lower half
e) Heavy duty solar powered self actuating ball valve controls the air flow to create oxygen starved condition in the processing unit
f) The decomposing reaction within MSW initiated when controlled quantity of air is allowed to enter in to the processing compartment with high magnetic vibration created by passing it through series of high power rare earth magnets in a specially designed cylinder configuration
g) Quantity of air and thereby oxygen which is controlled by the valves is derived and passed through the typical cylindrical arrangements of combination of rare earth magnets to produce highly unstable and activated ionized oxygen atoms which initiate the series of exothermic chain reactions to destroy the total mass contained in the vessel
h) After the initial spark/ignition, the process of destruction starts slowly by ionized air by splitting the molecules in to the atoms, atoms due to high magnetic vibration further ionized as outer electrons jumps away from its balanced designated orbits and thereby liberating immense heat which further used to destabilized the neighboring organic molecules
i) Ionized plasma state air vortex generated in oxygen starved condition with high magnetic vibration flows in upward direction to decompose and to destroy the MSW.

2. A non-combustion system without stirrer for destroy of waste material as claimed in claim 1, comprises:
a) Manual and automatic dumping systems are designed to feed in to the chamber of vessel at prescribed intervals
b) When MSW is dumped for the first time, it requires starting fire by using lighter/camphor/dry wood/match stick or by fire balls
c) Ignition starts in the vessels
d) As all the doors are closed and ignition starts momentarily, the temperature rises gradually
e) The specified volume of air allowed to entered through plasma generator which produce ionized air and subsequent heat by exothermic chain reaction
f) Heat generated in step e dehumidifies the MSW of the upper layer and decomposes the dry MSW of the lower level
g) The MSW turns in to ceramic ash due to decomposition caused by immense heat and some non hazardous gas emits in the process
h) Flue gas is further filtered by different equipments provided at the outlet to exhaust clean gas and subsequently emitted to atmosphere from the chimney
i) The wet MSW after dehumidification enters in to the high temperature lower zone of vassal to get converted further in to ceramic ash after due decomposition.

3. A non-combustion system without stirrer for decomposition of waste material by Automatic operation of machine
a. The process of decomposition is ideal for almost all types of waste and needs no segregation of waste , hence bin lifter lifts up unsegregated solid waste and inserted in the system through waste inlet door/lid
b. Electrical actuator automatically operates opening and closing of waste inlet lid whenever system sense ‘no waste condition’
c. Electric lighter ignites the waste when starting for the first time or after off-condition.
d. Mechanism commences with plasma generation by opening of motorized ball valve
e. Plasma generator and ball valves actuated by supply of electrical signals and starts producing ionized air and thereby plasma in the body.
f. Control panel is programmed to sense real time temperature for creating and stabilizing plasma generation for effective and efficient decomposition of waste
g. Depending upon the quantity and moisture content of the solid waste inserted in the system, effective decomposition continues at preferred temperature by automatic control of plasma generator.
h. Liberation of emission gases passing through filters and expelled out from chimney
